(19) United States
(12) Patent Application Publication
(10) Pub. No.: US 2010/0313138 A1
(43) Pub. Date: Dec. 9, 2010

(54) METHOD OF MANAGING USER REPRESENTATIONS, CORRESPONDING MANAGING ENTITY, TERMINAL AND COMPUTER PROGRAM

(75) Inventors: Louis Pare, Lannion (FR); Philippe Horville, Nanterre (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/746,065

(22) PCT Filed: Dec. 5, 2008
(86) PCT No.: PCT/FR2008/052212

§ 371 Date: Jul. 26, 2010

(30) Foreign Application Priority Data
Dec. 7, 2007 (FR) 0759657

(51) Int. Cl. G06F 3/01; G06F 15/16

(52) U.S. Cl. 715/744

(57) ABSTRACT

A method is provided for managing at least one representation of a user in a virtual environment. The method includes adapting the representation of a given user which is intended to be replayed to at least one other user, the adaptation being executed as a function of at least one comparison between at least one characteristic specific to the given user and at least one characteristic sought by the other user. The adaptation executed for each of the representations of the set of users.

### CROSS-REFERENCE TO RELATED APPLICATIONS

This application is a Section 371 National Stage Application of International Application No. PCT/FR2008/052212, filed Dec. 5, 2008 and published as WO 2009/080945 on Jul. 2, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure pertains to the information-processing management of virtual environments such as “virtual worlds”, for example enabling users to meet one another virtually through their respective terminals. More specifically, the disclosure pertains to the management of representations of users who can be represented by avatars acting in these virtual environments.

Here below in this document, the notions of environments and virtual worlds shall be used equally, without any bearing on the understanding of the disclosure.

A virtual environment can be seen as a representation of a particular universe in which users from the real world are present in the form of avatars. An avatar is a representation of a user made by means of a set of parameters. Such a representation can take the form of an image or of an animated object.

Thus, within a virtual world known as an “immersive” world, such a representation generally corresponds to the result of computations, sometimes complex ones, performed on the basis of various parameters proper to a user. Such a representation may be 2D or 3D and may progress in real time, both according to parameters and/or actions performed by the user in the virtual world and according to actions performed by other users (or their respective avatars) acting within a same virtual world. A virtual world is said to be immersive when the user is plunged into this world by means of a representation of a space and of users, for example in three dimensions. The term used then is “user immersion”.

### BACKGROUND OF THE DISCLOSURE

In a virtual environment, encounters between avatars enable the users represented by these avatars to have exchanges with one another.

In general, a user initially chooses to meet another user on the basis of the visual appearance of the latter's avatar, and then at a second stage on the basis of the characteristics that are defined by this user and are not shown visually through his avatar.

The visual appearance of a user is chosen by the user who represents it, namely its “owner”, and can take the form of a representation incorporating criteria such as size, eye color, hair, clothing style etc.

The visual appearance of an avatar can also be supplemented by characteristic graphic indicators of the user, for example a basketball, bicycle or any attribute for representing one or more of the user's characteristics.

One drawback of this way of representing an avatar lies in the fact that it is only the owners of the avatars who choose the visual appearance of their respective avatars. Thus, the visual appearance of each avatar depends on the reference system of its owner, and this reference system could be different from those of the other users (for example a user whose height is 1.70 m could choose a tall avatar while another user will not consider 1.70 m to be tall).

Another drawback of this prior-art technique is that, in an environment in which a large number of avatars are acting, it becomes difficult to have encounters based solely on the physical appearance of the avatars.

### SUMMARY

An aspect of the disclosure relates to a method for managing user representations in at least one virtual environment.

According to an embodiment of the invention, such a method includes a step of adapting the representation of a given user that is to be rendered to at least one other user, said adaptation being executed according to at least one comparison between at least one own characteristic of said given user and at least one characteristic sought by said other user.

Thus, an embodiment of the invention relies on a novel and inventive approach to the representation of users in a virtual environment, in a manner that is optimized and personalized for each user at his terminal.

According to one embodiment of the invention, said adaptation step is executed for each of the representations of all the users.

Thus, all the representations of all the users in a virtual environment are adapted according to the users that view them.

According to one particular embodiment of the invention, said adaptation step comprises the following steps:
comparing at least one own characteristic of said user with at least one corresponding sought characteristic of said other user, delivering a first piece of concordance information;
comparing at least one of said characteristics sought by said given user with at least one corresponding own characteristic of the user, delivering a second piece of concordance information;
updating, in a memory associated with said environment and/or with at least one of said representations, at least one data base of concordance information according to said first and second pieces of concordance information;
modifying the appearance of the representation associated with said given user and having to be rendered to a terminal of said other user, according to the pieces of information stored in said data base.

Indeed, the method according to an embodiment of the invention can be used to adapt, and therefore if necessary to personalize, the representation of the user who will be viewed by another user at his or her terminal as function of pieces of concordance information obtained from characteristics of the users concerned.

Thus, the visual aspect of an avatar associated with a given user may be different depending on the user viewing him or her, especially according to pieces of concordance information associated with the given user and according to the user who is viewing him or her.

The method according to an embodiment of the invention uses, for a given user, characteristics defined by this user, some of which represent the user himself (his or her own characteristics) and others of which represent characteristics sought in other users by the given user.

For a given user, several pieces of concordance information are obtained, for each of the other users of the environment, or only for the users located in the field of vision of the given user.

These pieces of concordance information are obtained by comparing sought characteristics of the given user with each of the other concerned users' own characteristics and by comparing the given user's own characteristics with the sought characteristics of the other users considered.

Thus, for a given user, the following are obtained: a first piece of concordance information indicating whether a considered user corresponds to what the given user is looking for and a second piece of concordance information indicating whether the given user corresponds to what this same considered user is looking for.

These pieces of concordance information are managed in a memory associated with each of the representations of the user or globally with the virtual environment in which the representations of the users are acting. These pieces of information are for example stored and updated in one or more data bases.

According to one variant, the adaptation of the representation of a user is done dynamically and does not call for the storage of these pieces of concordance information.

According to one particular characteristic, said steps for comparing implement a computation of a distance between a given user's own characteristics and another user's own corresponding sought characteristics.

Thus, the method according to an embodiment of the invention carries out a computation of a semantic distance between two characteristics to determine whether or not they are identical.

In general, the user's own and sought characteristics are chosen by users from a list of characteristics predefined by an entity for managing the virtual environment. The comparison between two characteristics may therefore consist of a strict comparison between two strings of characters or a weighted comparison that makes it possible to consider characteristics as being non-identical but close (for example if we compare a characteristic indicating a height, it is possible to take account of the strict equality between two heights or else equality ±5 centimeters).

According to one particular aspect of an embodiment of the invention, said step of modifying appearance implements a first type of modification if said first and second pieces of concordance information are below a predetermined threshold.

Thus, the method of an embodiment of the invention makes it possible to modify the visual aspect of a representation according to a degree of concordance obtained between the user who visualizes this representation and the user who possesses this representation. Should the concordance be reciprocal (the two users are looking for each other), then modifying the representation corresponds to a first type which enables the user to directly visualize the fact that another user corresponds to him or her and vice versa.

According to another aspect, said step of modifying appearance implements a second type of modification if said first piece of concordance information is below a predetermined threshold and said second piece of concordance information is above said threshold.

This case corresponds to a degree of concordance different from the one described here above (reciprocal concordance). Indeed, in this case, the concordance is asymmetrical, non-reciprocal between the given user and another user: this other user corresponding to what the given user is looking for while the given user himself or herself does not correspond to what this other user is looking for. In this case, an embodiment of the invention provides for modifying, according to a second type, the aspect of the representation of this other user so that the given user directly sees the degree of concordance that links them together.

According to another aspect, said step of modifying appearance implements a third type of modification if said second piece of concordance information is below a predetermined threshold and said first piece of concordance information is above said threshold.

This case also corresponds to a degree of concordance different from that of reciprocal concordance where the given user corresponds to what another user is looking for but this other user does not correspond to what the given user is looking for. The modification of the representation of the other user corresponds to a third type and here too enables the user to view the degree of concordance that links him or her to the user whose representation he or she is viewing.

According to one particular embodiment, said step of adaptation associates, with the representation of said given user .and in the vicinity of this representation, at least one distinctive symbol representing a degree of concordance that takes account of said first and second pieces of concordance information.

Thus, the method of an embodiment of the invention does not in itself modify the representation of the user but associates an additional graphic element with it.

For example, the adaptation may consist of the adding, at the side of or above or beneath the avatar, of a graphic element with a color and shape that is different depending on the degree of concordance.

In particular, the first type of modification described here above may correspond for example to the adding of a green-colored graphic shape at the side of or above the representation of a user which corresponds to the user who views it and vice versa.

The second type of modification may correspond to the adding of this same graphic shape in a different color, for example orange, and the third type may correspond to the addition of the same graphic shape in a third color, yellow for example.

Thus, the user can swiftly identify the user or users that correspond to him or her by looking for green graphic shapes.

According to another embodiment, said adaptation step modifies at least one visual characteristic of said representation according to a degree of concordance taking account of said first and second pieces of concordance information.

Thus, the adapting of the representation of the user consists of the modification of the representation itself, in changing one of its visual characteristics. For example, a particular degree of concordance may be expressed visually by a change in color of the clothing of the representation, for example in green, orange or yellow, to take up the example described here above.

The two embodiments are not exclusive and may be implemented simultaneously, for example to reinforce distinction between the representations according to the different degrees of concordance which bind them to the user viewing them.

According to one particular aspect of an embodiment of the invention, the method comprises displaying, on the terminal of said user, of at least one piece of information representing the number of the other users presenting a predetermined degree of concordance with said other user and for which the representation is situated in at least one field of vision of the representation of said other user.

Thus, the given user can also know how many users corresponding to him or her are moving in his or her field of vision or in a proximate “field of vision” corresponding to a predefined region of the virtual environment (for example easily accessible from the place in which he is located). This display can take the form of a picture indicating the number of users corresponding to each degree of concordance sought for the user (for example x “green” users, y “orange” users and z “yellow” users), in the user's field of vision, in one or more predefined regions of the virtual environment or in the overall virtual environment.

Another aspect of an embodiment of the invention concerns an entity for managing users' representations in at least one virtual environment.

According to an embodiment of the invention, such an entity comprises means for adapting the representation of a given user that is to be rendered to at least one other user, said adaptation means being adapted to make at least one comparison between at least one own characteristic of said given user and at least one characteristic sought by said other user.

According to one particular embodiment of the invention, said adaptation means comprise:
means for comparing at least one of said given user's own characteristics with at least one corresponding sought characteristic of said other user, delivering a first piece of concordance information;
means for comparing at least one of said characteristics sought by said given user with at least one own characteristic corresponding to the other user, delivering a second piece of concordance information;
means for updating, in a memory associated with said environment and/or with at least one of said representations, at least one data base of concordance information according to said first and second pieces of concordance information;
means for modifying the appearance of the representation that is associated with said given user and is to be rendered to a terminal of said other user, according to the pieces of information stored in said data base.

Such an entity is capable especially of implementing the method for managing described here above. The entity is, for example, a server managing representations of the users in at least one virtual environment.

Another aspect of an embodiment of the invention concerns a user terminal connected to an entity for managing users' representations in at least one virtual environment.

According to an embodiment of the invention, such a terminal comprises means for adapting the representation of a given user, that is to be rendered to at least one other user, said adaptation means being adapted to make at least one comparison between at least one own characteristic of said given user and at least one characteristic sought by said other user.

According to one particular embodiment of the invention, said adaptation means comprise means for adapting the representation associated with said at least one other user, according to pieces of information stored in at least one data base, said data base of pieces of concordance information being stored in a memory associated with said environment and/or with at least one of said representations, said data base being updated according to a first and a second piece of concordance information, said first piece of concordance information representing a comparison of at least one of said characteristics sought by said given user with at least one own characteristic corresponding to another user, and said second piece of concordance information representing a comparison of at least one of said own characteristics of said given user with at least one sought characteristic corresponding to at least one other user.

An embodiment of the invention finally pertains to a computer program product downloadable from a communications network and/or recorded on a computer-readable carrier and/or executable by a microprocessor, comprising program code instructions for executing the method for managing as described here above.

### BRIEF DESCRIPTION OF THE DRAWINGS

Other features and advantages shall appear more clearly in the following description of a preferred embodiment given by way of a simple illustratory and non-exhaustive example, and from the appended drawings, of which:

FIG. 1 illustrates an example of a general system for implementing the method of an embodiment of the invention;

FIG. 2 presents main steps of the method according to one embodiment of the invention, in a system of the kind described with reference to FIG. 1;

FIG. 3 is a diagram of sequences of a particular embodiment of the method;

FIGS. 4a and 4b respectively present an example of a table of concordance for a user and an example of an overall table of concordance according to two particular embodiments of the invention;

FIG. 5 illustrates a portion of a virtual environment viewed by a user according to a particular embodiment of the invention;

FIG. 6 presents the structure of a managing entity according to one particular embodiment of the invention.

### DETAILED DESCRIPTION OF ILLUSTRATIVE EMBODIMENTS

### 1. General Principle

The general principle of an embodiment of the invention relies on the management of pieces of concordance information that are cross-checked between the different representations of the users in an immersive virtual environment offering users possibilities of meeting one another. These pieces of concordance information are stored in a memory, for example in one or more data bases. This memory is associated with the above-mentioned virtual environment or with one or more representations of users moving in this virtual environment.

For example, these pieces of concordance information are stored and updated in a concordance table.

On the basis of this table of concordance, the method of an embodiment of the invention defines different visual aspects for the representations of the users according to a degree of concordance in taking account of the concordance information of the table.

Indeed, in order to facilitate meetings between users, it is very useful for them to make use of tools for rapidly viewing other users likely to interest them in terms of encounters. Indeed, such environments often arouse much enthusiasm and the number of users moving therein may be very great. In this case, it may be difficult to make a selection between users likely to be interesting or uninteresting. The method of an embodiment of the invention makes it possible to modify the visual aspect for a given user of a representation of another user according to the degree of concordance between the given user and another user. This concordance may be computed symmetrically or reciprocally, the aspect of the representation of the other user may be different according to the degree of concordance in one sense or the other (i.e. if the other user corresponds more or less to what the given user is looking for, and also if the given user corresponds more or less to what the other user is looking for).

An embodiment of the invention relies on characteristics associated with each of the representations of the users managed for example in the form of lists in the virtual environment.

In particular, for a representation of a given user, the managing entity controls a first list containing at least one characteristic proper to the user (for example to his height and/or the color of his eyes and/or a hobby) and a second list containing at least one characteristic sought in another user (for example his height and/or the color of his eyes and/or a hobby etc.).

According to an embodiment of the invention, the managing entity makes cross-comparisons of the characteristics of the first and second lists of the given user and a set of other users in order to obtain information items on concordance.

According to one embodiment of the invention, the managing entity manages these pieces of concordance information in a concordance table stored in the memory, and determines the different aspects of each user according to the information stored in the table of concordance.

This concordance information may be represented in the form of a degree of concordance between the given user and each of the other users.

This degree of concordance may also correspond to the result of a processing or of one or more of these pieces of concordance information, for example by applying for particular weighting to one or more pieces of information.

In one particular embodiment of the invention, this degree of concordance takes the form, within the virtual environment, of a distinctive sign or symbol associated with the representations of the users. For example, this distinctive sign may be a colored geometrical shape (an arc of a circle, a sphere) placed in proximity to an avatar. The color of this geometrical shape varies according to the degree of concordance relative to the characteristics sought by the user. Thus, for example a representation of a first user corresponding perfectly to the characteristics sought by a second user will possess a green geometrical shape if the characteristics sought by the first user also correspond perfectly to the characteristics of the first user (i.e. if there is reciprocity). Other indicator means (luminosity, color, flashing etc) may of course be envisaged.

A user representation that does not correspond at all to the characteristics sought by another user will either possess no geometrical shape whatoever or will possess a distinctive geometrical shape, for example colored black or red.

An intermediate color (orange for example) could be presented if only certain criteria are met (for example a sharing of certain areas of interest) or if there is no reciprocity.

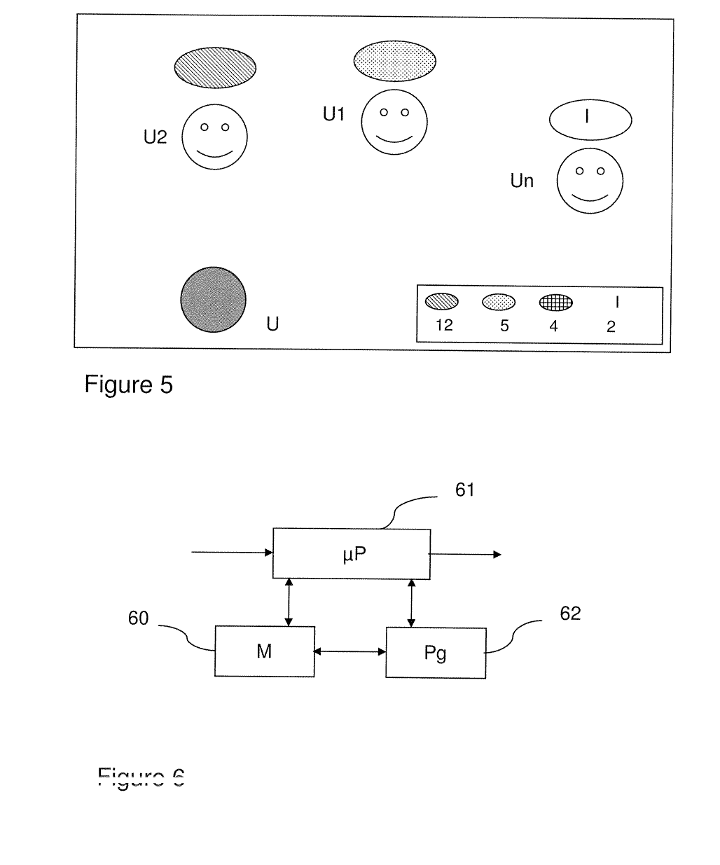

FIG. 5 described in greater detail here below illustrates an example of an environment viewed by a user.

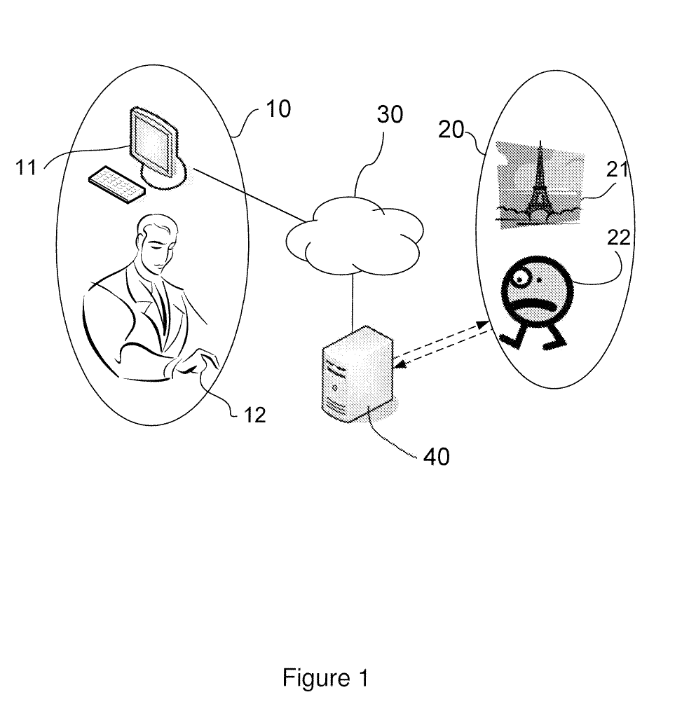

Referring now to FIG. 1, we present an example of a system in which the method is implemented according to one embodiment of the invention.

In the real world 10, each user 12 accesses a virtual environment 20 through an immersion terminal 11 (for example a computer but any other immersion system can of course be envisaged, for example a telephone, a PDA etc).

Each virtual world 20 comprises:
one or more virtual spaces 21;
users' representations or avatars 22 representing the users 12 of the real world.
a communications network 30 enabling the immersion terminals 11 to communicate with each other as well with servers 40;
servers or control entities on the servers 40 fulfilling a role of coordination, distribution and storage.

In the virtual world 20, a user 12 from the real world 10 is represented by his avatar 22. In the real world 10, the user 12 drives his user representation 22 and sees the visual field viewed by this avatar 22 by means of the immersion terminal 11.

### 2. Description of One Embodiment

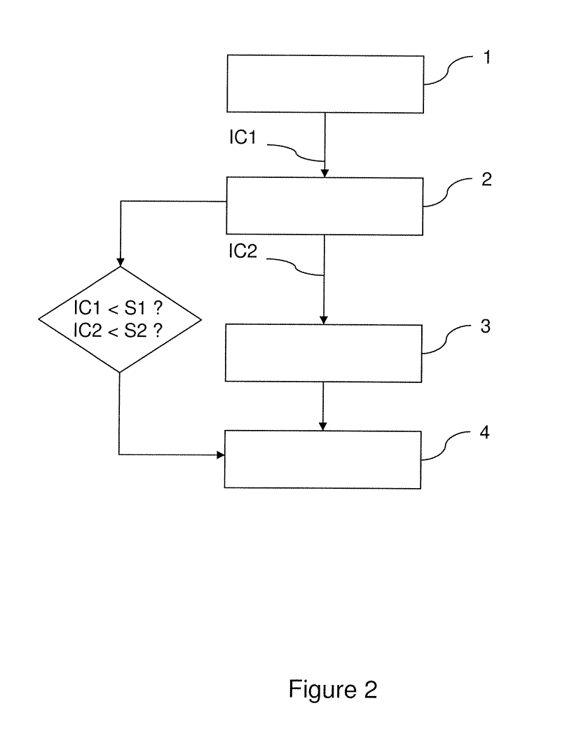

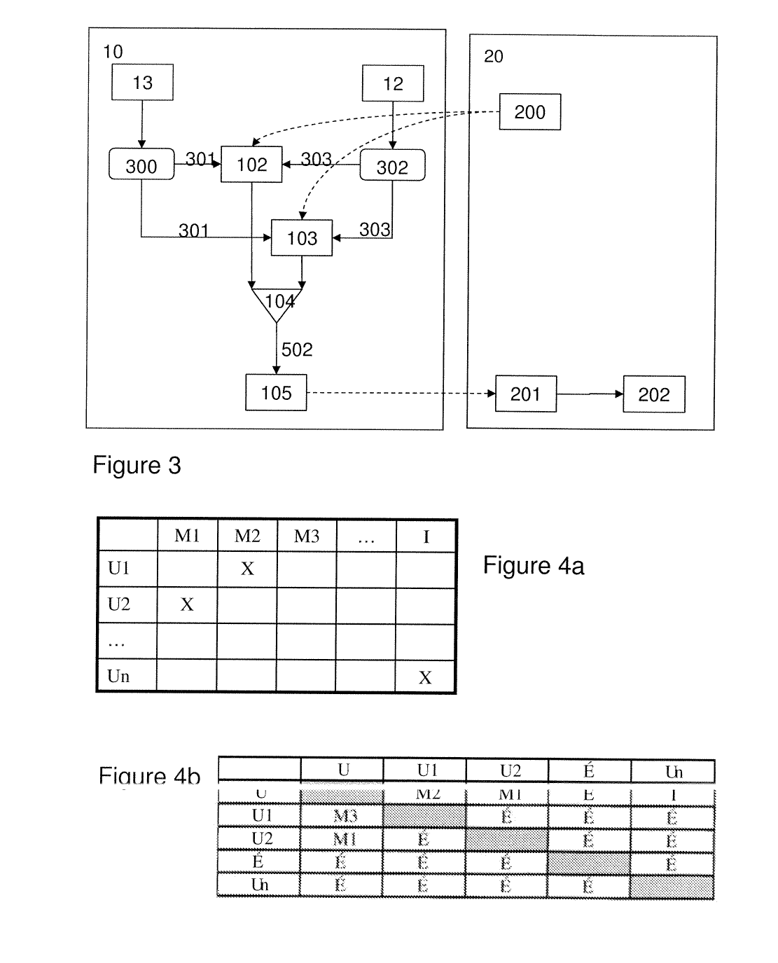

Referring now to FIGS. 2 and 3, we present the main steps of the method according to one embodiment of the invention implemented in a system such as the one described here below with reference to FIG. 1.

We consider a user U (12) represented by an avatar A (22) and a user 13 represented by an avatar B acting in a virtual environment such as the one described here above.

During a first comparison step 1, the method of this embodiment of the invention compares one or more sought characteristics of the user U with one or more own characteristics of the user 13.

At the end of this comparison, a first piece of concordance information IC1 is obtained. This concordance information may correspond to a computation of distance between characteristics and can therefore be compared with the threshold S1 in order to determine whether 13 corresponds more or less to what U is looking for. If the concordance information IC1 is below the predetermined threshold S1, then the distance between the characteristics proper to 13 and those sought by U are sufficiently small to be able to consider 13 to correspond to what U is looking for.

During a second comparison step 2, a piece of concordance information IC2 is obtained by comparing one or more sought characteristics of the user 13 with one or more own characteristics of the user U.

Then, during an updating step 3, the pieces of concordance information IC1 and IC2 obtained previously are updated, for example in a data base stored in a memory associated with the avatar A. This data base can also be associated with the environment in which the avatars A and B are acting.

The method of an embodiment of the invention also ascertains that the piece of concordance information IC1 is above or below a threshold S2 (identical to or different from the threshold S1) in order to determine whether U corresponds more or corresponds less to what 13 is looking for

The pieces of concordance information IC1 and IC2 as well as the comparison of these pieces with the thresholds 51 and S2 make it possible to define a degree of concordance between the users U and 13.

This degree of concordance indicates whether U corresponds to what 13 is looking for and vice versa or whether only one of the relationships is verified.

Depending on this degree of concordance, a step 4 for matching the visual aspect of the avatar B is performed so that the user U directly sees the degree of concordance that links them.

### 3. Example of Implementation

Referring to FIGS. 3 to 5, we now present an example of implementation of the method for managing according to the above-described embodiment, for the user U (12).

In the real world 10, an immersion device enables the user 13 to make modifications, in a container 300 (using a dedicated application for example), in his or her characteristics 301 known as “possessed” characteristics (i.e. his or her own characteristics) and to make modifications, in a container 302, of the characteristics 303 known as “sought” characteristics among the users that he or she wishes to meet.

The container 300, for example a file or a data base, stores the characteristics possessed 301 by each user in the real world (for example eye color, height, favorite sports etc).

The container 302, for example a file or a data base, stores the characteristics sought 303 by each user from the real world (for example eye color, height, favorite sports etc).

In the virtual environment 20, a method 200 determines which are the avatars present in the field of vision of the user U and transmits the identifiers in the users concerned (for example U1 and U2 illustrated in FIG. 5) to the method for managing according to an embodiment of the invention.

At the simultaneous or successive processing steps 102 and 103, a concordance table (described in greater detail with reference to FIG. 4 here below) is updated for the users concerned.

For example, the characteristics sought 303 by the user U correspond to the characteristics possessed 301 by the user 13 while it is deemed to be the case that the users 13 and U are in concordance in one sense, i.e. that the user U is seeking the user 13.

The method of an embodiment of the invention also checks to see if the concordance is reciprocal, i.e. if the characteristics possessed by the user U correspond to the characteristics sought by the user 13 (in this case, the user 13 is seeking the user U).

If the concordance is verified in at least one of the two senses, a piece of information 502 is transmitted in a step 104 enabling a choice of the visual aspect of the representation of the user 13 according to the degree of concordance.

For example the signal 502 may contain an attribute indicating the color of the distinctive sign associated with the avatar of the user 13:
color=green if the user U is seeking the user 13 and vice versa,
color=orange if the user U is seeking the user 13 but the user 13 is not seeking the user U,
color=yellow if the user U is not seeking the user 13 but the user 13 is seeking the user U.

The representative information 502 sent to the real/virtual interface 104 and to an interface 201 (in the virtual environment) prompts a graphic display 202 on the terminal of the user U especially with the avatar of the user 13 represented according to the degree of concordance between the user U and the user 13.

### 3.1 Examples of a Concordance Table

Referring now to FIGS. 4a and 4b, we present two examples of concordance tables, the first for the user U according to the users who move in his or her field of vision at a given point in time and the second for all the users according to the other users.

We therefore consider the users U1, U2 . . . , Un moving in the field of vision of the user U.

It is also deemed to be the case that the modifications made in the appearance of the representations of the users correspond, as described here above, to a distinctive sign associated with the avatar, having a different color according to the degree of concordance.

FIG. 4a illustrates an example of a concordance table associated with the user U, for example stored and updated by the entity for managing the user's representations.

To return to the example described in detail here above, the modification denoted as M1, M2 or M3 made to an avatar is deemed to correspond respectively to a distinctive sign (for example an oval geometrical shape above the avatar) colored red green, yellow or orange.

For example the user U is a man and has the following characteristics: brown hair, blue eyes, height=1 m 75.

The user U is looking for the following characteristics in a woman: red hair, green eyes, height=1 m 60.

The users U1, U2 and Un are women.

U1 possesses the following characteristics: red hair, green eyes, height=1 m 60.

U1 is looking for the following characteristics in a man: blonde hair, blue eyes, height—1 m 80.

U2 possesses the following characteristics: red hair, green eyes, height=1 m 60.

U2 is looking for the following characteristics in a man: brown hair, blue eyes, height=1 m 75.

User Un specifies that she does not wish to meet any man who is shorter than 1 m 80 and wishes to be shown as being unavailable to all users shorter than 1 m 80.

According to the different characteristics listed here above, the concordance table, for the user U, is updated as follows when the users U1 and U2 and Un are in the user U's field of vision:
the modification associated with the representation of the user U1, seen by the user U is denoted as M2 and corresponds to a distinctive sign colored orange, indicating that the user U is seeking the user U1 but that the user U1 is not seeking the user U,
the modification made by the avatar of the user U2 is denoted as M2 and corresponds to a distinctive green sign indicating that the user U is seeking the user U2 and that the user U2 is seeking the user U,
the user Un is seen as being unavailable to the user U.

In the example illustrated in FIG. 4b, the modifications M1, M2, M3 or I are updated for all the users relatively to the other users.

Thus, in this concordance table with two entries, each user is characterized by the modification corresponding to its avatar, for each of the other users.

If we again take the users U, U1, U2 and Un of the previous example, it can be seen in the table of FIG. 4 that, for the user U, the user U1 is well represented with a modification M2 and the user U2 is well represented with a modification M1.

Similarly, and reciprocally, for the user U1, the user U appears with the modification M3 which is reciprocal to M2.

Finally, for the user U2, the user U also appears with a modification M1.

This table therefore makes it possible to provide each of the users with a personalized and optimized representation of each of the other users who are in his or her field of vision.

### 3.2 Example of an Environment Viewed by a User

Referring now to FIG. 5, we present an example of an environment viewed by the user U according to the embodiment described here above resulting from the concordance table as described here above.

The user U therefore sees the avatars of the users U1, U2 and Un in his field of vision.

Apart from their visual aspect chosen by their respective users, these avatars each have a distinctive sign as described here above.

In FIG. 5, green is represented by diagonal streaks, orange by dots and dashes and yellow by a grid pattern.

The avatar of the user U2 is therefore represented by a streaked oval shape and the avatar of the user U1 is represented by an oval shape having dots.

The avatar of the user Un is represented with an indication of unavailability.

At the bottom left corner of his environment, the user U can also view the total number of avatars respectively having green, orange and yellow spheres in the environment in which the user U is located.

These indications may be restricted to the user U's field of vision or else to one or more regions of the proximate virtual environment close to the place where the user U is currently located (this case is shown in the figure). These indications may also relate to the entire virtual environment.

Thus, these indications can indicate the number of “green” users in a radius of 100 m around the place in which the user U is located so as to inform him of the places where he can move in a preferred manner to try and meet other users who correspond to him.

### 4. Structure of the Managing Entity

Referring to FIG. 6, we present the simplified structure of an entity for managing according to the embodiment described here above.

A managing entity such as this comprises a memory 60 constituted by a buffer memory, a processing unit 61 equipped for example with a microprocessor μP and driven by the computer program 62 implementing the method for managing according to an embodiment of the invention.

At initialization, the code instructions of the computer program 62 are loaded for example into a RAM and then executed by the processor of the processing unit 61. At input, the processing unit 61 receives own characteristics of a set of users and sought characteristics of a set of users. The microprocessor of the processing unit 61 implements the steps of the method for managing described here above according to the instructions of the computer program 62 to make cross comparisons between the own characteristics and the sought characteristics and to update a concordance table stored for example in the memory 60. To this end, the managing entity comprises, in addition to the buffer memory 60, means for comparing at least one of said characteristics sought by said given user with at least one corresponding own characteristic of at least one other user, delivering a first piece of concordance information, means for comparing at least one of said own characteristics of said given user with at least one corresponding sought characteristic of at least one other user delivering a second piece of concordance information, means for the updating, in a memory associated with said environment and/or with at least one of said representations, of at least one data base of concordance information according to said first and second pieces of concordance information; and means for adapting the representation associated with said given user and having to be rendered to a terminal of said other user, according to the pieces of information stored in said data base. These means are driven by the microprocessor of the processor unit 61.

Although the present disclosure has been described with reference to one or more examples, workers skilled in the art will recognize that changes may be made in form and detail without departing from the scope of the disclosure and/or the appended claims.

1. A method for managing at least one representation of a user in a virtual environment, wherein the method comprises:
a step of adapting the representation of a given user that is to be rendered to at least one other user, wherein the step of adapting is executed according to at least one comparison between at least one own characteristic of said given user and at least one characteristic sought by said other user.

2. The method for managing according to claim 1, wherein said step of adapting is executed for each of the representations of all the users.

3. The method for managing according to claim 1, wherein said step of adapting comprises:
comparing at least one own characteristic of said user with at least one corresponding sought characteristic of said other user, delivering a first piece of concordance information;
comparing at least one of said characteristics sought by said given user with at least one corresponding own characteristic of the user, delivering a second piece of concordance information;
updating, in a memory associated with at least one of said environment or at least one of said representations, at least one data base of concordance information according to said first and second pieces of concordance information; and
modifying an appearance of the representation associated with said given user and having to be rendered to a terminal of said other user, according to the pieces of information stored in said data base.

4. The method according to claim 3, wherein the steps of comparing implement a computation of a distance between a given user's own characteristics and corresponding own sought characteristics of another user.

5. The method according to claim 3, wherein said step of modifying the appearance implements a type of modification if said first and second pieces of concordance information are below a predetermined threshold.

6. The method according to claim 3, wherein said step of modifying the appearance implements a type of modification if said first piece of concordance information is below a predetermined threshold and said second piece of concordance information is above said threshold.

7. The method according to claim 3, wherein said step of modifying the appearance implements a type of modification if said second piece of concordance information is below a predetermined threshold and said first piece of concordance information is above said threshold.

8. The method according to claim 3, wherein said step of adapting associates, with the representation of said given user and in a vicinity of this representation, at least one distinctive symbol representing a degree of concordance that takes account of said first and second pieces of concordance information.

9. The method according to claim 3, wherein said step of adapting modifies at least one visual characteristic of said representation according to a degree of concordance taking account of said first and second pieces of concordance information.

10. The method according to claim 1, wherein the method comprises displaying on a terminal of said user, at least one piece of information representing the number of the other users presenting a predetermined degree of concordance with said other user and for which the representation is situated in at least one field of vision of the representation of said other user.

11. An entity for managing at least one representation of a user in at least one virtual environment, wherein the entity comprises:
means for adapting the representation of a given user that is to be rendered to at least one other user, said means for adapting being adapted to make at least one comparison between at least one own characteristic of said given user and at least one characteristic sought by said other user.

12. The entity according to claim 11, wherein said means for adapting comprise:
means for comparing at least one of said given user's own characteristics with at least one corresponding sought characteristic of said other user, delivering a first piece of concordance information;
means for comparing at least one of said characteristics sought by said given user with at least one own characteristic corresponding to the other user, delivering a second piece of concordance information;
means for updating, in a memory associated with at least one of said environment or at least one of said representations, at least one data base of concordance information according to said first and second pieces of concordance information; and
means for modifying the appearance of the representation that is associated with said given user and is to be rendered to a terminal of said other user, according to the pieces of information stored in said data base.

13. A user terminal connected to an entity for managing at least one representation of a user in at least one virtual environment, wherein the user terminal comprises:
means for adapting the representation of a given user that is to be rendered to at least one other user, said means for adapting being adapted to make at least one comparison between at least one own characteristic of said given user and at least one characteristic sought by said other user.

14. A computer program product recorded on a computer-readable carrier and executable by a microprocessor, comprising program code instructions for executing a method of for managing at least one representation of a user in a virtual environment, when the instructions are executed on a computer, wherein the method comprises:
a step of adapting the representation of a given user that is to be rendered to at least one other user, wherein the step of adapting is executed according to at least one comparison between at least one own characteristic of said given user and at least one characteristic sought by said other user.
